(19) United States
(12) Patent Application Publication
(10) Pub. No.: US 2025/0028547 A1
(43) Pub. Date: Jan. 23, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Takashi MURAKAMI, Kanagawa (JP); Manabu HAYASHI, Kanagawa (JP)

(73) Assignee: FUJIFILM Business Innovation Corp., Tokyo (JP)

(21) Appl. No.: 18/593,967

(22) Filed: Mar. 3, 2024

(30) Foreign Application Priority Data
Jul. 21, 2023 (JP) 2023-119507

(51) Int. Cl. G06F 9/451; H04N 1/00

(52) U.S. Cl. CPC G06F 9/453; H04N 1/00464; H04N 1/0048

(57) ABSTRACT

An information processing system includes a processor configured to: detect a state necessitating a setting change; and perform a process of highlighting a setting change menu on a web user interface in a case in which the web user interface is accessed after the detection of the state.

### CROSS-REFERENCE TO RELATED APPLICATIONS

This application is based on and claims priority under 35 USC 119 from Japanese Patent Application No. 2023-119507 filed Jul. 21, 2023.

### BACKGROUND

### (i) Technical Field

The present disclosure relates to an information processing system and a non-transitory computer readable medium.

### (ii) Related Art

Japanese Patent No. 4873032 discloses a user interface device which includes: a user authentication unit; an operation history recording unit that records information about an operation performed by a user as an operation history record; a current user operation frequency counting unit that outputs the number of operations performed by a logged-in user as a current user operation frequency counting result; a non-current user operation frequency counting unit that outputs the number of operations performed by a user other than the logged-in user as a non-current user operation frequency counting result; and a guidance item display order determination unit that determines, based on the non-current user operation frequency counting result, a presentation priority for a guidance item so that the presentation priority for a guidance item having a relatively high operation frequency by the non-current user increases, corrects, based on the current user operation frequency counting result, the presentation priority so that the presentation priority for a guidance item related to an operation with a relatively high operation frequency by the current user decreases, and determines a presentation priority.

### SUMMARY

Since keyboard input is convenient for inputting a setting item or the like having a large number of characters, an apparatus is equipped with a function of providing guidance for a setting change from a web user interface. Upon moving from the function to the web user interface, a setting change menu is highlighted for the user who wants to change a setting. However, since the setting may be already completed, it is not appropriate to always highlight the setting change menu.

Aspects of non-limiting exemplary embodiments of the present disclosure relate to providing an information processing system and an information processing program capable of improving user convenience compared to when a setting change menu is always highlighted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: detect a state necessitating a setting change; and perform a process of highlighting a setting change menu on a web user interface in a case in which the web user interface is accessed after the detection of the state.

### BRIEF DESCRIPTION OF THE DRAWINGS

Exemplary embodiments of the present disclosure will be described in detail based on the following figures, wherein:

FIG. 1 is a diagram illustrating a schematic configuration of an information processing system according to an exemplary embodiment;

FIG. 2 is a block diagram illustrating a configuration of the major portions of an electrical system of an image forming apparatus in the information processing system according to the present exemplary embodiment;

FIG. 3 is a block diagram illustrating a configuration of the major portions of an electrical system of a client computer and a portable terminal device in the information processing system according to the present exemplary embodiment;

FIG. 4 is a block diagram illustrating an example of a functional configuration of a control unit;

FIG. 5 is a diagram for describing a launch of a navigation application;

FIG. 6 is a diagram illustrating an example of highlighting of a setting change menu in a first exemplary embodiment;

FIG. 7 is a flowchart of an example of the flow of a process starting from an operation of a user interface in the control unit of the image forming apparatus according to the first exemplary embodiment;

FIG. 8 is a flowchart of an example of the flow of a process starting from an operation of a web user interface (UI) in the control unit of the image forming apparatus according to the first exemplary embodiment;

FIG. 9 is a diagram illustrating examples of functions necessitating advance setting, and required setting items;

FIG. 10 is a diagram for describing a case in which mail transmission is selected and launched as an example of a function requiring advance setting;

FIG. 11 is a diagram illustrating an example of highlighting of the setting change menu in a second exemplary embodiment;

FIG. 12 is a flowchart of an example of the flow of a process starting from an operation of the user interface in the control unit of the image forming apparatus according to the second exemplary embodiment;

FIG. 13 is a flowchart of an example of the flow of a process starting from an operation of the web UI in the control unit of the image forming apparatus according to the second exemplary embodiment;

FIG. 14 is a diagram illustrating an example of highlighting of the setting change menu in a third exemplary embodiment;

FIG. 15 is a flowchart of an example of the flow of a process performed in the control unit of the image forming apparatus according to the third exemplary embodiment;

FIG. 16 is a flowchart of an example of the flow of a process starting from an operation of the web UI in the control unit of the image forming apparatus according to the third exemplary embodiment;

FIG. 17 is a diagram illustrating an example of highlighting of the setting change menu in a fourth exemplary embodiment;

FIG. 18 is a flowchart of an example of the flow of a process performed in the control unit of the image forming apparatus according to the fourth exemplary embodiment; and

FIG. 19 is a flowchart of an example of the flow of a process starting from an operation of the web UI in the control unit of the image forming apparatus according to the fourth exemplary embodiment.

### DETAILED DESCRIPTION

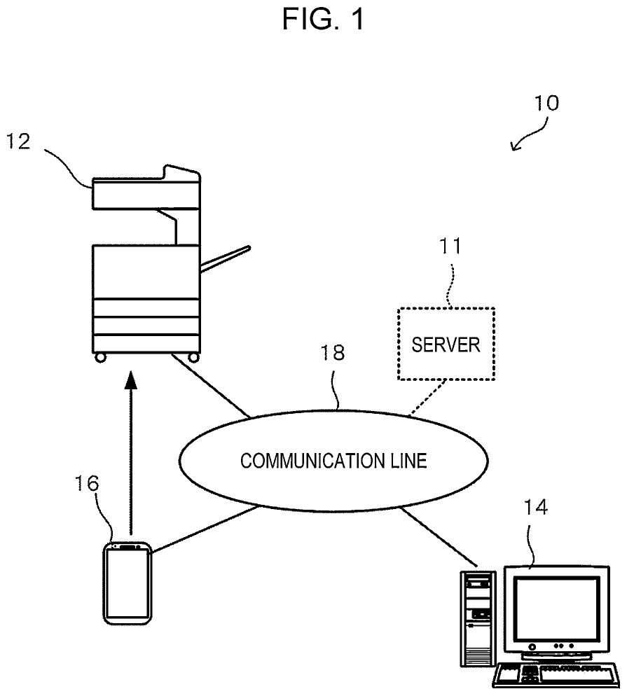

In the following, an example of an exemplary embodiment will be described in detail with reference to the drawings. In the present exemplary embodiment, an information processing system will be described as an example, in which an image forming apparatus, a client computer, a portable terminal device, and the like are connected to each other via a communication line, such as various networks. FIG. 1 is a diagram illustrating a schematic configuration of an information processing system 10 according to the present exemplary embodiment.

As illustrated in FIG. 1, the information processing system 10 according to the present exemplary embodiment includes an image forming apparatus 12, a client computer 14, and a portable terminal device 16. The image forming apparatus 12 and the client computer 14 are connected to each other via a communication line 18, such as a local area network (LAN), a wide area network (WAN), the Internet, or an intranet. The image forming apparatus 12, the client computer 14, and the portable terminal device 16 can transmit and receive various data to and from each other via the communication line 18. In the present exemplary embodiment, when the client computer 14 or the portable terminal device 16 instructs the image forming apparatus 12 to perform printing, the image forming apparatus 12 forms an image corresponding to the print instruction. While FIG. 1 illustrates one each of the image forming apparatus 12, the client computer 14, and the portable terminal device 16, there may be a plurality of each or any of them. Further, in the information processing system 10 according to the present exemplary embodiment, the portable terminal device 16 can issue a print instruction via short-range wireless communication, such as Wi-Fi (registered trademark) or Bluetooth (registered trademark), in addition to via the communication line 18. Note that as indicated by the dotted line in FIG. 1, the information processing system 10 may further include a server 11, and an image formation request may be made to the image forming apparatus 12 from at least one of the client computer 14 and the portable terminal device 16 via the server 11.

The image forming apparatus 12 according to the present exemplary embodiment has a plurality of functions, such as: an image forming function of receiving various data from the client computer 14 or the portable terminal device 16 and performing an image forming process based on the received data; a reading function of reading a document to obtain image information representing the document; a copying function of copying an image recorded on a document onto a sheet; a facsimile function of transmitting and receiving various data via a telephone line (not illustrated); a transfer function of transferring document information, such as image information read by the reading function; and a storage function of storing document information, such as image information that has been read. The plurality of functions may include all of the above functions or two or more of the functions.

In the following description, the facsimile function may be referred to as facsimile, the reading function may be referred to as scanning, the image forming function may be referred to as printing, and the copying function may be referred to as copying.

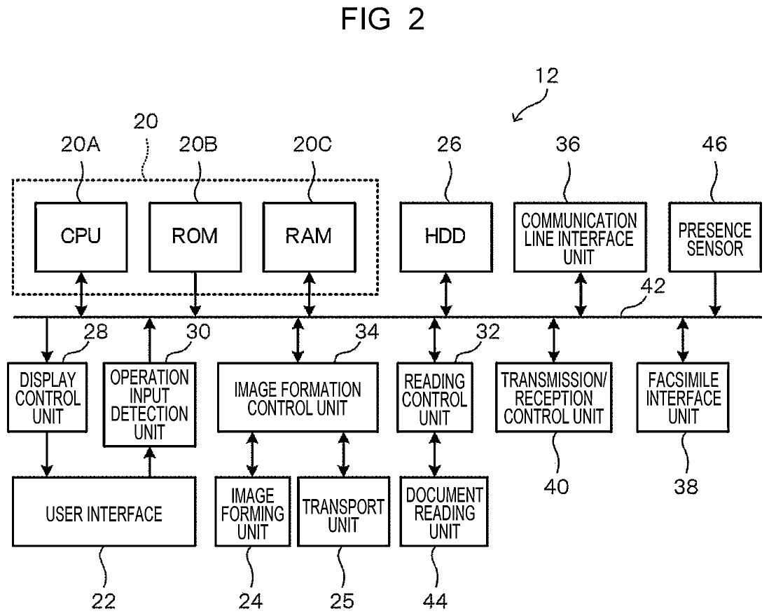

FIG. 2 is a block diagram illustrating a configuration of the major portions of an electrical system of the image forming apparatus 12 in the information processing system 10 according to the present exemplary embodiment.

As illustrated in FIG. 2, the image forming apparatus 12 according to the present exemplary embodiment includes a control unit 20 which includes a central processing unit (CPU) 20A, a read only memory (ROM) 20B, and a random access memory (RAM) 20C. The CPU 20A governs the overall operation of the image forming apparatus 12. The RAM 20C is used as a work area or the like during execution of various programs by the CPU 20A. In the ROM 20B, various control programs, such as application programs, various parameters, and the like are stored in advance. In the image forming apparatus 12, the sections of the control unit 20 are electrically connected by a system bus 42.

The image forming apparatus 12 according to the present exemplary embodiment includes a hard disk drive (HDD) 26 that stores various data, application programs, and the like. The image forming apparatus 12 further includes a display control unit 28 that is connected to a user interface 22 to control the display of various operation screens and the like on a display of the user interface 22. The image forming apparatus 12 also includes an operation input detection unit 30 that is connected to the user interface 22 to detect an operation instruction input via the user interface 22. In the image forming apparatus 12, the HDD 26, the display control unit 28, and the operation input detection unit 30 are electrically connected to the system bus 42. In the image forming apparatus 12 according to the present exemplary embodiment, the HDD 26 is used as a storage unit. However, this is not a limitation, and a non-volatile storage unit, such as a flash memory, may be used. In the present exemplary embodiment, a touch panel that enables display and operation input is used as the user interface 22. However, this is not a limitation, and a user interface in which a display and an operating unit are separate from each other may be used.

Further, the image forming apparatus 12 according to the present exemplary embodiment includes: a reading control unit 32 that controls an optical image reading operation by a document reading unit 44 and a document feeding operation by a document transport unit; and an image formation control unit 34 that controls an image forming process by an image forming unit 24 and the transport of a sheet to the image forming unit 24 by a transport unit 25. In addition, the image forming apparatus 12 includes a communication line interface (I/F) unit 36 that is connected to the communication line 18 to transmit and receive communication data to and from another external device, such as the client computer 14 connected to the communication line 18. The image forming apparatus 12 further includes a facsimile interface (I/F) unit 38 that is connected to a telephone line (not illustrated) to transmit and receive facsimile data to and from a facsimile device connected to the telephone line. The image forming apparatus 12 further includes a transmission/reception control unit 40 that controls the transmission and reception of facsimile data via the facsimile I/F unit 38. Further, the image forming apparatus 12 includes a presence sensor 46 that detects a person around the apparatus. In the image forming apparatus 12, the transmission/reception control unit 40, the reading control unit 32, the image formation control unit 34, the communication line I/F unit 36, the facsimile I/F unit 38, and the presence sensor 46 are electrically connected to the system bus 42.

In the above configuration, the image forming apparatus 12 according to the present exemplary embodiment uses the CPU 20A to perform access to each of the RAM 20C, the ROM 20B, and the HDD 26. Further, the image forming apparatus 12 uses the CPU 20A to perform control of the display of an operation screen and information, such as various messages, on the display of the user interface 22 via the display control unit 28. Further, the image forming apparatus 12 uses the CPU 20A to perform control of the operation of the document reading unit 44 and the document transport unit via the reading control unit 32. The image forming apparatus 12 also uses the CPU 20A to perform control of the operation of the image forming unit 24 and the transport unit 25 via the image formation control unit 34, and control of transmission and reception of communication data via the communication line I/F unit 36. Further, the image forming apparatus 12 uses the CPU 20A to perform control of transmission and reception of facsimile data via the facsimile I/F unit 38 by the transmission/reception control unit 40. Further, the image forming apparatus 12 uses the CPU 20A to ascertain operation contents in the user interface 22 based on operation information detected by the operation input detection unit 30, and to perform various kinds of control based on the operation contents.

Examples of the applications stored in the ROM 20B or the HDD 26 in the present exemplary embodiment include applications for executing the functions of facsimile, scanning, printing, copying, and the like.

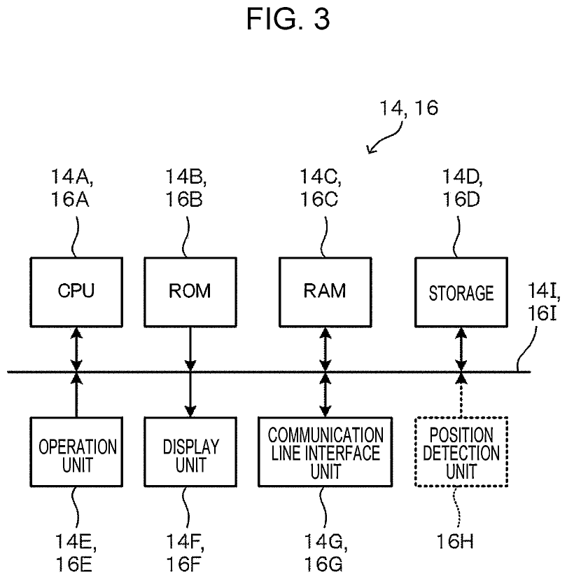

Next, the configuration of the major portions of an electrical system of the client computer 14 according to the present exemplary embodiment will be described. FIG. 3 is a block diagram illustrating the configuration of the major portions of the electrical system of the client computer 14 and the portable terminal device 16 in the information processing system 10 according to the present exemplary embodiment.

As illustrated in FIG. 3, the client computer 14 according to the present exemplary embodiment includes a CPU 14A, a ROM 14B, a RAM 14C, a storage 14D, an operation unit 14E, a display unit 14F, and a communication line interface (I/F) unit 14G. The CPU 14A governs the overall operation of the client computer 14. Various control programs, various parameters, and the like are stored in advance in the ROM 14B. The RAM 14C is used as a work area or the like during execution of various programs by the CPU 14A. The storage 14D stores various kinds of data, application programs, and the like. The operation unit 14E is used to input various kinds of information. The display unit 14F is used to display various kinds of information. The communication line I/F unit 14G is connected to the communication line 18, and performs transmission and reception of various kinds of data with the other devices connected to the communication line 18. The communication line I/F unit 14G may be configured to be able to directly communicate with each of the devices using various well-known kinds of wireless communication. The units of the client computer 14 are electrically connected to each other by a system bus 14I. In the client computer 14 according to the present exemplary embodiment, the storage 14D is used as a storage unit. As an example of the storage, a nonvolatile storage unit such as a hard disk drive (HDD) or a flash memory is used.

In the above configuration, the client computer 14 according to the present exemplary embodiment uses the CPU 14A to perform access to the ROM 14B, the RAM 14C, and the storage 14D, acquisition of various kinds of data through the operation unit 14E, and displaying of various kinds of information on the display unit 14F. Further, the client computer 14 uses the CPU 14A to perform control of transmission and reception of communication data via the communication line I/F unit 14G.

Detailed description of a case in which a print instruction is issued from the portable terminal device 16 is omitted because the portable terminal device 16 basically includes a general computer configuration similar to the client computer 14 of FIG. 3, with a CPU 16A, a ROM 16B, a RAM 16C, and the like. The portable terminal device 16 includes a position detection unit 16H for detecting the position of the portable terminal device 16 by Global Positioning System (GPS) or the like, and an imaging unit (not illustrated), such as a camera, as components that are not present in the client computer 14.

The image forming apparatus 12 may include a web user interface (UI) that is set by accessing the image forming apparatus 12 with a browser. For example, for setting items that involve a large amount of character input, such as the setting of a mail address and the setting of a user name or a password when a user is added, it is more convenient to make the setting from the web UI that enables input by the keyboard of the client computer 14 or the like, or by an operation unit 16E of the portable terminal device 16, than from the user interface 22 provided in the image forming apparatus 12.

Furthermore, in order to provide guidance to the user toward the setting change from the more convenient web UI, the image forming apparatus 12 includes a navigation application. When the user opens the navigation application from the user interface of the image forming apparatus 12, the user is presented with information for an access by a browser, such as a Uniform Resource Locator (URL) of an access destination or a two-dimensional code including the URL, or the user can print a report describing such information, for example.

The web UI enables not only the setting change but also various operations, such as file-upload printing, extraction of scan/fax reception data stored in the image forming apparatus 12, and address book editing. Thus, to guide a user who wants to make a setting change in a readily understandable manner, a link or an icon for a setting change menu is highlighted.

Generally, a setting change in the image forming apparatus 12 is limited to a user having the authority to make the setting change, such as the machine administrator. However, a user who does not have the authority to make a setting change also accesses the web UI. In addition, a setting change itself is often already completed. Therefore, it is not appropriate to always highlight the setting change menu on the web UI.

In order to switch the display of Web content for individual users, a cookie that identifies the client may be utilized. However, since a plurality of users access the web UI of the image forming apparatus 12 from different browsers, switching in this form is difficult.

In a possible solution, a plurality of access destination URLs for the web UI may be prepared, such as a URL for highlighted display and a URL for non-highlighted display. However, this may impair convenience because the user is required to select and use different access destinations, more likely resulting in an erroneous operation, such as accessing an unintended one of the access destinations.

As described above, the setting change menu needs to be highlighted appropriately on the web UI in accordance with the mode of utilization of the image forming apparatus 12.

Thus, in the image forming apparatus 12 according to the present exemplary embodiment, a state necessitating a setting change is detected, and if the web user interface is accessed after the detection of the state, a process to highlight the setting change menu on the web UI is performed. In this way, user convenience can be improved compared with the case in which the setting change menu is always highlighted.

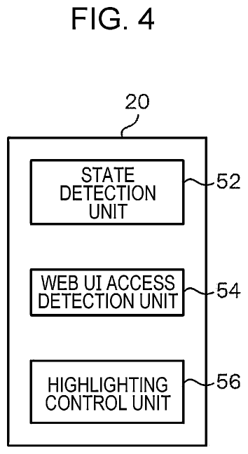

For example, as illustrated in FIG. 4, the control unit 20 has the functions of a state detection unit 52, a web UI access detection unit 54, and a highlighting control unit 56. Each function is implemented by the CPU 20A of the control unit 20 loading a program stored in the ROM 20B into the RAM 20C and executing the program. FIG. 4 is a block diagram illustrating an example of the functional configuration of the control unit 20.

The state detection unit 52 detects a state necessitating a setting change in the image forming apparatus 12. As an example of the state necessitating a setting change, the state detection unit 52 detects a launch of a navigation application and stores a launch history because the navigation application provides guidance concerning a setting change from the web UI. In other examples of the state necessitating a setting change, the state detection unit 52 detects the occurrence of a launch error due to a function requiring advance setting being launched in an unset state, the occurrence of an error necessitating a setting change, and an update of predetermined software. When the occurrence of an error is detected, an error history is stored in the HDD 26 or the like. When a software update is detected, a processing result is stored in the HDD 26 or the like.

The web UI access detection unit 54 detects a user's request to access the web UI, and provides the web UI to the requesting user.

The highlighting control unit 56 determines whether to highlight the setting change menu based on the results of detection by the state detection unit 52 and the web UI access detection unit 54, and controls the highlighting of the setting change menu. For example, the highlighting control unit 56 performs control to highlight the setting change menu if the web user interface is accessed after the state detection unit 52 detected a state necessitating a setting change.

Hereinafter, processing performed by each function of the control unit 20 will be specifically described.

### First Exemplary Embodiment

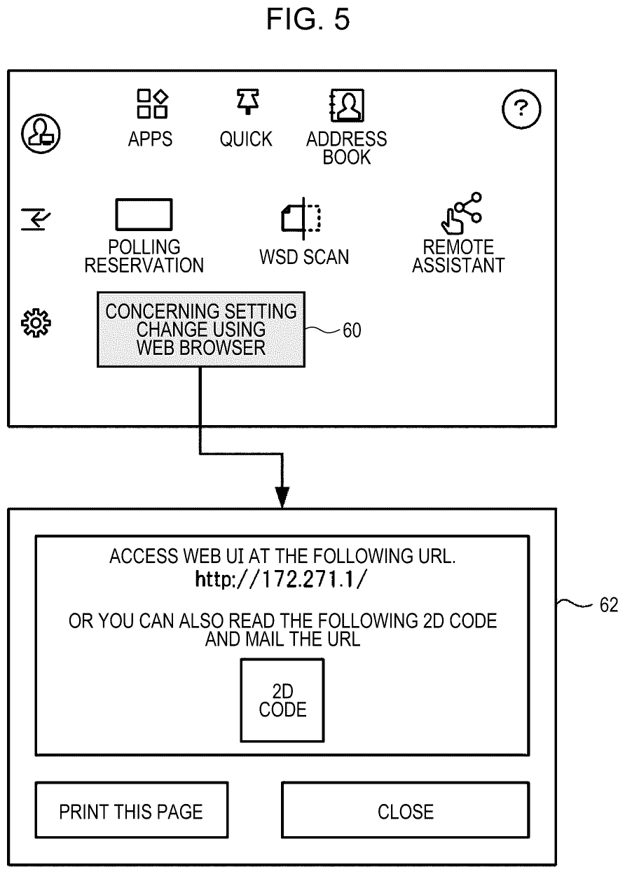

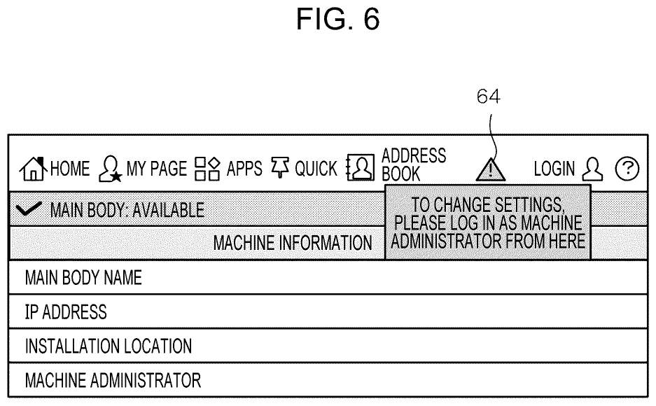

In the present exemplary embodiment, a case will be described in which the state detection unit 52 detects a launch of a navigation application as an example of the state necessitating a setting change. FIG. 5 is a diagram for describing the launch of a navigation application. FIG. 6 is a diagram illustrating an example of highlighting of the setting change menu in the present exemplary embodiment.

For example, as illustrated in the upper portion of FIG. 5, the image forming apparatus 12 displays a navigation application icon 60 representing the navigation application as a guidance application, on the user interface 22.

Here, when the navigation application icon 60 is operated, a guide screen 62 for the web UI that includes the access destination URL of the web UI, a two-dimensional code, a button for instructing printing of the access destination, and the like is displayed, as illustrated in the lower portion of FIG. 5.

In the image forming apparatus 12, the state detection unit 52 detects that the navigation application has been launched on the user interface 22, and stores a launch history in the HDD 26 or the like. The launch history of the navigation application is deleted after a predetermined time elapses.

If the web UI is accessed within a prescribed time after the navigation application is launched, the image forming apparatus 12 determines that the user has been given a guidance toward the web UI by the navigation application, i.e., that the user has accessed the web UI for the purpose of making a setting change, and the highlighting control unit 56 highlights the setting change menu on the web UI to provide an easily understandable guide for making a setting change, as illustrated in FIG. 6. In the example of FIG. 6, an alert icon 64 is highlighted, with an indication “To change settings, please log in as machine administrator from here”.

In the present exemplary embodiment, an example in which the state detection unit 52 detects the launch of the navigation application has been described. However, as the launch of the navigation application, an instruction to display the guide screen 62 or the display of the guide screen 62 may be detected. Further, the guidance toward the web UI is not limited to that in the form of the navigation application, but may be provided as the function of one item in the setting change menu that is to be used by the machine administrator in the user interface 22 of the image forming apparatus 12.

Now, a specific process performed in the control unit 20 of the image forming apparatus 12 according to the present exemplary embodiment will be described.

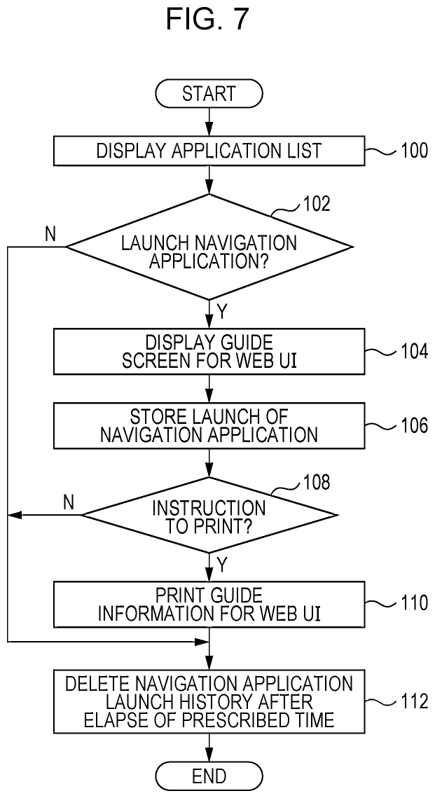

First, a process starting from an operation of the user interface 22 will be described. FIG. 7 is a flowchart of an example of the flow of the process starting from an operation of the user interface 22 in the control unit 20 of the image forming apparatus 12 according to the present exemplary embodiment. The processing of FIG. 7 starts, for example, when displaying of a menu screen of the image forming apparatus 12 is instructed.

In step 100, the CPU 20A displays an application list representing each function of the image forming apparatus 12, and the process proceeds to step 102. For example, the application list is displayed as illustrated in the upper portion of FIG. 5.

In step 102, the CPU 20A determines whether the navigation application has been launched. In this determination, for example, it is determined whether the navigation application icon 60 illustrated in FIG. 5 has been operated. If the determination is affirmative, the process proceeds to step 104; if negative, the process proceeds to step 110.

In step 104, the CPU 20A displays a guide screen for the web UI on the user interface 22, and the process proceeds to step 106. For example, as illustrated in FIG. 5, the guide screen 62 is displayed on the user interface 22.

In step 106, the CPU 20A stores the launch of the navigating application, and the process proceeds to step 108.

In step 108, the CPU 20A determines whether printing has been instructed. In this determination, for example, it is determined whether a button (“Print this page” in FIG. 5) for instructing printing of the access destination as illustrated in the lower portion of FIG. 5 has been operated. If the determination is affirmative, the process proceeds to step 110; if negative, the process proceeds to step 112.

In step 110, the CPU 20A prints the guide information for the web UI, and the process proceeds to step 112.

In step 112, the CPU 20A deletes the launch history of the navigation application after a predetermined and prescribed time has elapsed, and ends the processing sequence.

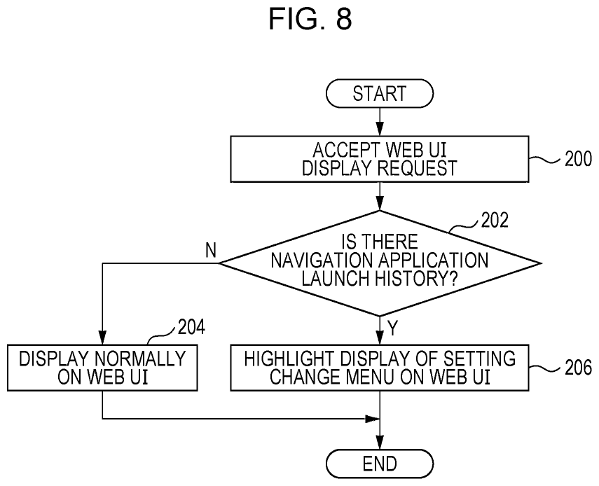

Next, a process starting from an operation of the web UI will be described. FIG. 8 is a flowchart of an example of the flow of the process starting from an operation of the web UI in the control unit 20 of the image forming apparatus 12 according to the present exemplary embodiment. Note that the process in FIG. 8 starts, for example, when display of the web UI is requested.

In step 200, the CPU 20A receives a request to display the web UI, and the process proceeds to step 202.

In step 202, the CPU 20A determines whether there is a launch history of the navigation application. In this determination, it is determined whether the launch history stored in the above-described step 106 remains without being deleted in step 112. If the determination is negative, the process proceeds to step 204; if affirmative, the process proceeds to step 206.

In step 204, the CPU 20A performs normal display on the web UI, and ends the processing sequence. That is, the web UI is displayed without being highlighted.

On the other hand, in step 206, the CPU 20A highlights the display of the setting change menu on the web UI, and ends the processing sequence. For example, as illustrated in FIG. 6, the alert icon 64 is highlighted, with an indication “To change settings, please log in as machine administrator from here”.

As described above, in the present exemplary embodiment, the setting change menu is highlighted if the web UI is accessed within the prescribed time after the launch of the navigating application is detected. Thus, the setting change menu is not always highlighted. Instead, the setting change menu can be highlighted on the web UI at the timing expected by the user, thus enhancing user convenience.

### Second Exemplary Embodiment

In the present exemplary embodiment, a case will be described in which the state detection unit 52 detects, as an example of the state necessitating a setting change, the occurrence of a launch error due to a function necessitating advance setting being launched in an unset state.

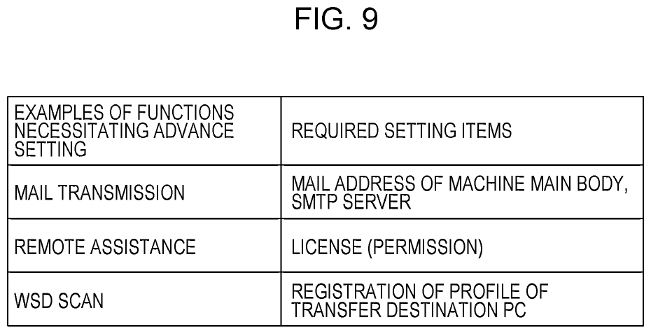

The image forming apparatus 12 has functions that require advance setting by the machine administrator in order to be utilized. The functions that require advance setting include, for example, mail transmission, remote assistance, and Web Service for Device (WSD) scan, as illustrated in FIG. 9. For mail transmission, settings of a mail address of the machine main body, a Simple Mail Transfer Protocol (SMTP) server, and the like are required setting items. For remote assistance, licensing is a required setting item. For the WSD scan, registration of a profile of a transfer destination personal computer (PC) is a required setting item. FIG. 9 is a diagram illustrating examples of the functions necessitating advance setting and the required setting items.

If these functions are launched in an unset state, a launch error occurs. In the image forming apparatus 12, the state detection unit 52 detects the occurrence of the launch error, and, upon detecting the launch error, stores a history of the launch error.

Then, if the web UI is accessed within a predetermined and prescribed time after the occurrence of the launch error, the highlighting control unit 56 highlights the setting change menu for the relevant function. The highlighted setting change menu is directly linked to a setting menu necessary for enabling the relevant function.

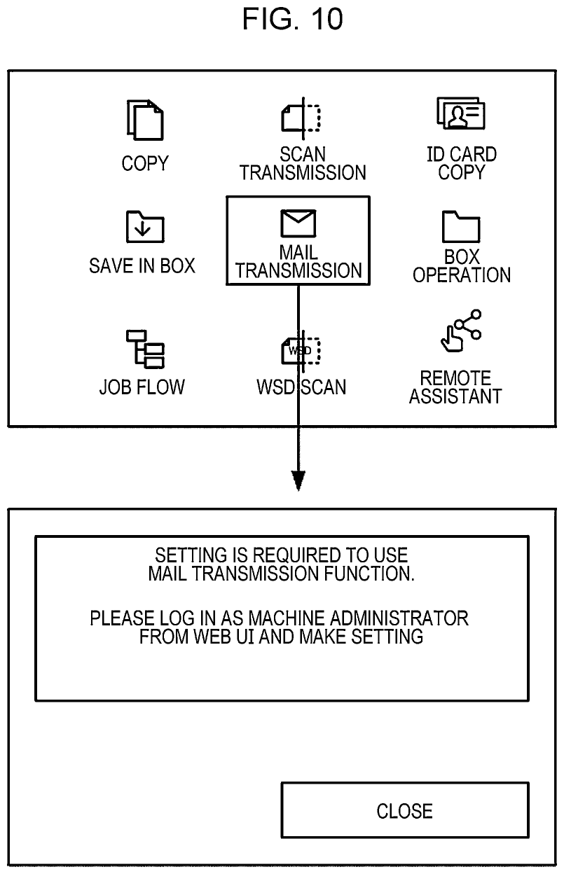

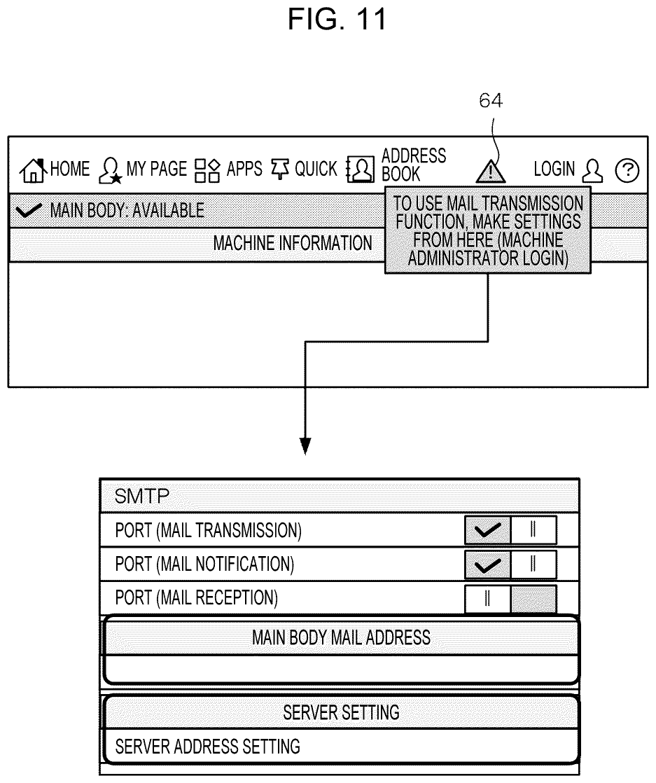

FIG. 10 is a diagram for describing a case in which mail transmission is selected and launched as an example of a function requiring advance setting. FIG. 11 is a diagram illustrating an example of highlighting of the setting change menu according to the present exemplary embodiment.

For example, if mail transmission is selected and launched in an unset state as illustrated in the upper portion of FIG. 10, a launch error occurs, and an error screen is displayed, as illustrated in the lower portion of FIG. 10. The example error screen in the lower portion of FIG. 10 indicates “Setting is required to use mail transmission function. Please log in from web UI as machine administrator and make setting”.

If the web UI is accessed within a prescribed time after the occurrence of the error, the alert icon 64 is highlighted, with an indication “To use mail transmission function, make settings from here”, as illustrated in the upper portion of FIG. 11. Then, if an operation is performed on the alert icon 64, a setting menu necessary for activating the mail transmission function is displayed, as illustrated in the lower portion of FIG. 11. In the example in the lower portion of FIG. 11, the main body mail address and server setting are each enclosed by a thick frame as necessary setting items.

In the present exemplary embodiment, the example in which the state detection unit 52 detects the occurrence of a launch error has been described. However, a display of the error screen may be detected as the occurrence of a launch error.

Now, a specific process performed in the control unit 20 of the image forming apparatus 12 according to the present exemplary embodiment will be described.

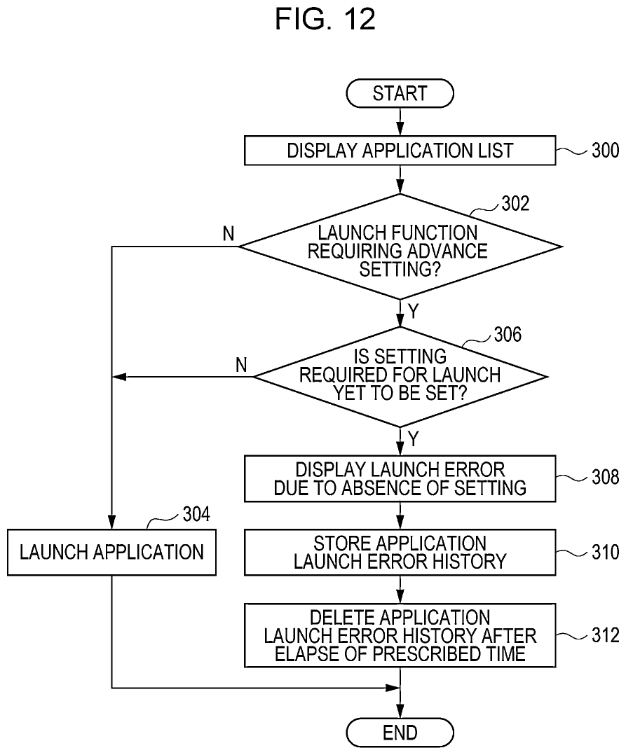

First, a process starting from an operation of the user interface 22 will be described. FIG. 12 is a flowchart of an example of the flow of the process starting from an operation of the user interface 22 in the control unit 20 of the image forming apparatus 12 according to the present exemplary embodiment. The process of FIG. 12 starts, for example, when displaying of a menu screen of the image forming apparatus 12 is instructed.

In step 300, the CPU 20A displays an application list representing each function of the image forming apparatus 12, and the process proceeds to step 302. For example, the application list is displayed as illustrated in the upper portion of FIG. 10.

In step 302, the CPU 20A determines whether a function requiring advance setting has been launched. In this determination, for example, it is determined whether any of the functions illustrated in FIG. 9 has been launched. If the determination is negative, the process proceeds to step 304; if affirmative, the process proceeds to step 306.

In step 304, the CPU 20A launches an application, ends the processing sequence, and performs the process of the launched application.

On the other hand, in step 306, the CPU 20A determines whether a setting necessary for the launch is yet to be set. In this determination, for example, it is determined whether the required setting item illustrated in FIG. 9 is yet to be set. If the determination is negative, the process proceeds to step 304 described above; if affirmative, the process proceeds to step 308.

In step 308, the CPU 20A displays a launch error due to the absence of setting, and the process proceeds to step 310. For example, if mail transmission is launched in an unset state as illustrated in the upper portion of FIG. 10, an indication “Setting is required to use mail transmission function. Please log in from web UI as machine administrator and make setting” is displayed, as illustrated in the lower portion of FIG. 10.

In step 310, the CPU 20A stores an application launch error history, and the process proceeds to step 312.

In step 312, the CPU 20A deletes the application launch error history after a predetermined and prescribed time has elapsed, and ends the processing sequence.

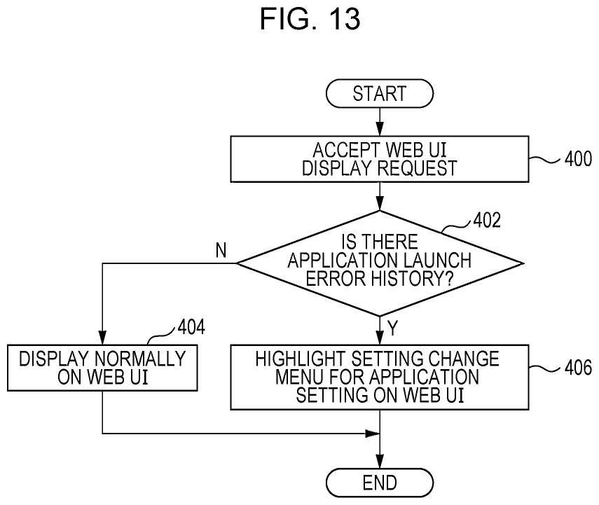

Next, a process starting from an operation of the web UI will be described. FIG. 13 is a flowchart of an example of the flow of the process starting from an operation of the web UI in the control unit 20 of the image forming apparatus 12 according to the present exemplary embodiment. The process of FIG. 13 starts, for example, when display of the web UI is requested.

In step 400, the CPU 20A receives a request to display the web UI, and the process proceeds to step 402.

In step 402, the CPU 20A determines whether there is an application launch error history. In this determination, it is determined whether the application launch error history stored in the above-described step 310 remains without being deleted in step 312. If the determination is negative, the process proceeds to step 404; if affirmative, the process proceeds to step 406.

In step 404, the CPU 20A performs normal display on the web UI, and ends the processing sequence. That is, the web UI is displayed without being highlighted.

On the other hand, in step 406, the CPU 20A highlights the setting change menu for application setting on the web UI, and ends the processing sequence. For example, as illustrated in the upper portion of FIG. 11, the alert icon 64 is highlighted, with an indication “To use mail transmission function, make settings from here”. Then, when an operation is performed on the alert icon 64, a setting menu necessary for activating the mail transmission function is displayed, as illustrated in the lower portion of FIG. 11.

As described above, in the present exemplary embodiment, the setting change menu is highlighted if the web UI is accessed within the prescribed time after the occurrence of a launch error due to a function requiring advance setting being launched in an unset state. Thus, the setting change menu is not always highlighted. Instead, the setting change menu can be highlighted on the web UI at the timing expected by the user, thus enhancing user convenience.

### Third Exemplary Embodiment

In the present exemplary embodiment, a case will be described in which the state detection unit 52 detects the occurrence of an error necessitating a setting change as an example of the state necessitating a setting change.

Even when the setting of the image forming apparatus 12 is completed, an error may occur in a process performed by the image forming apparatus 12 due to a change in the connected network environment, or the like.

For example, a user authentication error may occur because the encryption method of an authentication server that performs user authentication is changed to a more robust one.

In another example, a login error may occur because, although the function of selecting a transfer destination from an address book and performing scan-and-transmit has been implemented, the login password of the user in the PC of the transfer destination is changed by a regular update performed every three months.

In general, an error code is assigned to an error that occurs in the image forming apparatus 12, and a handling method is determined for each error code. Therefore, the image forming apparatus 12 can extract the setting item to be changed from the occurred error. For example, in the case of a user authentication error, a security setting is extracted as the setting item to be changed. If the error is due to “incorrect password” in the case of scan-and-store-in-PC in which the storage destination is selected from the address book, the password item of the address book is extracted.

Thus, if the web UI is accessed when an error is currently occurring or an error has occurred within a prescribed time in the past, the image forming apparatus 12 highlights a setting item menu necessary for eliminating the error. As an example, in the case of the user authentication error, “security setting” is highlighted as the setting item to be changed. In the case of the error of the scan-and-transmit function, “password item of the address book” is highlighted as the setting item to be changed.

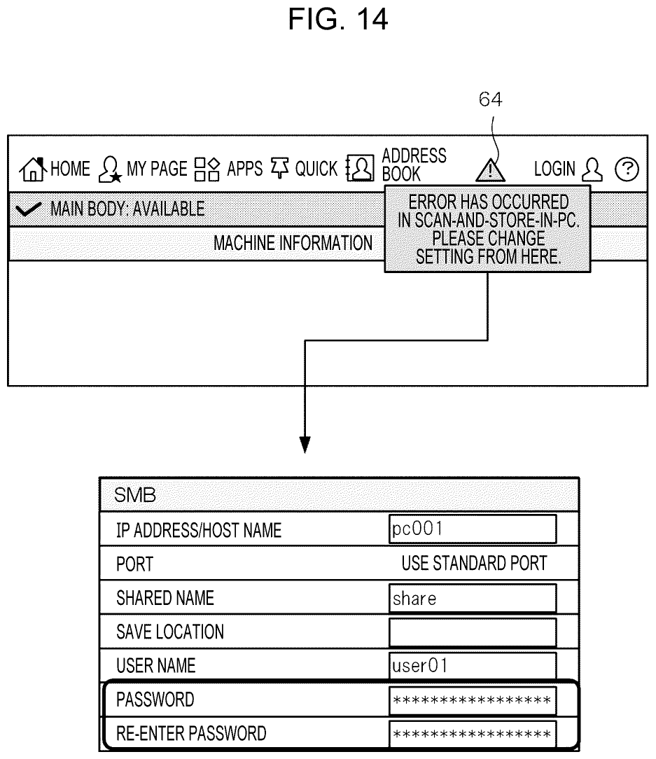

Specifically, highlighting is performed as illustrated in FIG. 14. FIG. 14 is a diagram illustrating an example of highlighting of the setting change menu according to the present exemplary embodiment.

That is, if the state detection unit 52 detects the occurrence of an error necessitating a setting change or the occurrence of an error within a prescribed time, the highlighting control unit 56 highlights the alert icon 64, with an indication “Error has occurred in scan-and-store-in-PC. Please change setting from here”, for example, as illustrated in the upper portion of FIG. 14. Then, when an operation is performed on the alert icon 64, the items necessary for eliminating the error are highlighted, as illustrated in the lower portion of FIG. 14. In the example in the lower portion of FIG. 14, the password portion is highlighted by being enclosed by a thick frame as the necessary setting items.

Now, a specific process performed in the control unit 20 of the image forming apparatus 12 according to the present exemplary embodiment will be described.

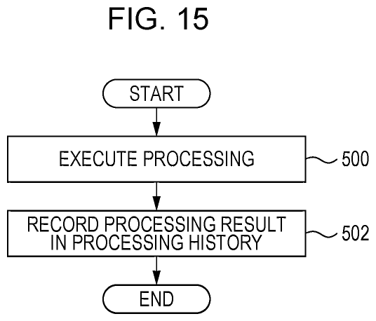

First, a process of the image forming apparatus 12 will be described. FIG. 15 is a flowchart illustrating an example of the flow of the process performed in the control unit 20 of the image forming apparatus 12 according to the present exemplary embodiment. The process of FIG. 15 is started, for example, when execution of a function selected by the user is instructed.

In step 500, the CPU 20A executes processing selected by the user, and the process proceeds to step 502.

In step 502, the CPU 20A stores a processing result in a processing history, and ends the processing sequence.

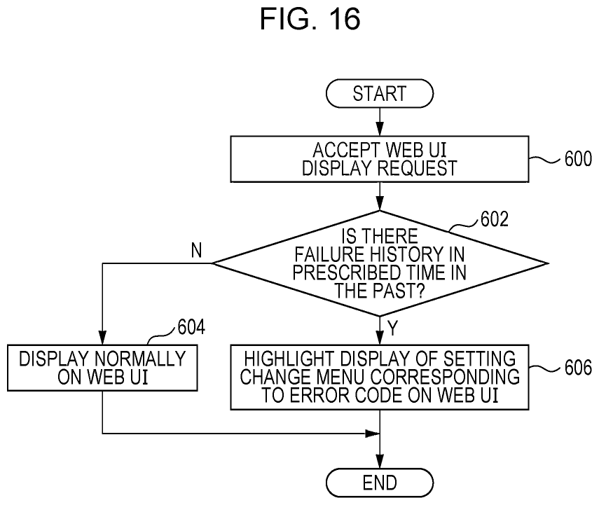

Next, a process starting from an operation of the web UI will be described. FIG. 16 is a flowchart of an example of the flow of the process starting from an operation of the web UI in the control unit 20 of the image forming apparatus 12 according to the present exemplary embodiment. The process of FIG. 16 starts, for example, when display of the web UI is requested.

In step 600, the CPU 20A receives a request to display the web UI, and the process proceeds to step 602.

In step 602, the CPU 20A determines whether there is a failure history within a predetermined and prescribed time in the past. In this determination, it is determined from the processing history whether there is a history of “failure” within a prescribed time from the current time. If the determination is negative, the process proceeds to step 604; if affirmative, the process proceeds to step 606.

In step 604, the CPU 20A performs normal display on the web UI, and ends the processing sequence. That is, the web UI is displayed without being highlighted.

On the other hand, in step 606, the CPU 20A highlights a setting change menu corresponding to the error code on the web UI, and ends the processing sequence. For example, as illustrated in the upper portion of FIG. 14, the alert icon 64 is highlighted, with an indication “Error has occurred in scan-and-store-in-PC. Please change setting from here”. Then, when an operation is performed on the alert icon 64, the items necessary for eliminating the error are highlighted, as illustrated in the lower portion of FIG. 14.

As described above, in the present exemplary embodiment, when an error necessitating a setting change occurs, or when the occurrence of an error is detected within a prescribed time, the setting change menu is highlighted. Thus, the setting change menu can be appropriately highlighted in accordance with the contents of an event even when the event is not started by the user. Therefore, the user can access and deal with the item to be changed earlier and more easily.

### Fourth Exemplary Embodiment

In the present exemplary embodiment, a case will be described in which the state detection unit 52 detects an update of predetermined software as an example of the state necessitating a setting change. Hereinafter, an example in which an update of firmware is detected will be described as an example of detection of predetermined software. However, the predetermined software is not limited to firmware, and an update of software that necessitates a setting change due to addition of a new function may be detected.

A new function may be added to the image forming apparatus 12 due to an update of software, such as firmware.

On the assumption that the user is going to make a setting for the new function, the image forming apparatus 12 highlights a setting menu for the new function on the web UI for a predetermined and prescribed time after the firmware update.

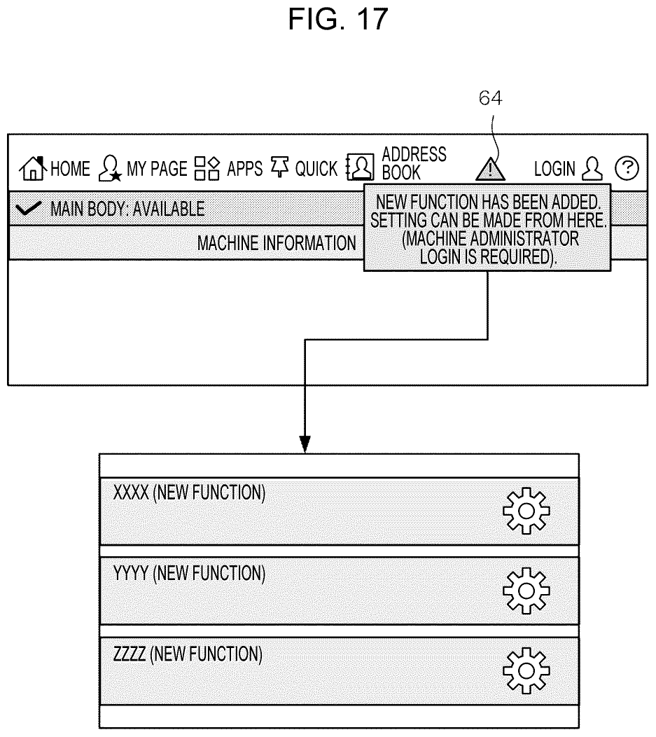

As an example, highlighting is performed as illustrated in FIG. 17. FIG. 17 is a diagram illustrating an example of highlighting of the setting change menu according to the present exemplary embodiment.

That is, if the state detection unit 52 detects an update of software, the highlighting control unit 56 highlights the alert icon 64, with an indication “New function has been added. Setting can be changed from here”, as illustrated in the upper portion of FIG. 17. Then, when an operation is performed on the alert icon 64, the new function items are displayed, as illustrated in the lower portion of FIG. 17.

Now, a specific process performed in the control unit 20 of the image forming apparatus 12 according to the present exemplary embodiment will be described.

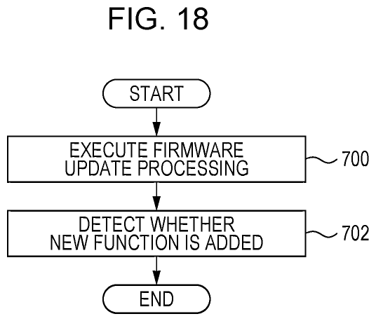

First, a process of the image forming apparatus 12 will be described. FIG. 18 is a flowchart illustrating an example of the flow of the process performed in the control unit 20 of the image forming apparatus 12 according to the present exemplary embodiment. The process of FIG. 18 is started, for example, when an instruction to update firmware is given, or when an update of firmware is detected.

In step 700, the CPU 20A performs firmware update processing, and the process proceeds to step 702.

In step 702, the CPU 20A detects whether a new function is added, and ends the processing sequence.

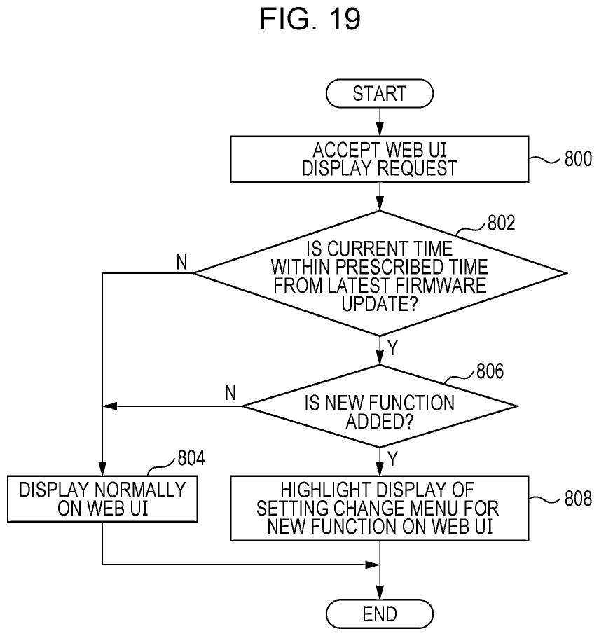

Next, a process starting from an operation of the web UI will be described. FIG. 19 is a flowchart of an example of the flow of the process starting from an operation of the web UI in the control unit 20 of the image forming apparatus 12 according to the present exemplary embodiment. The process of FIG. 19 starts, for example, when display of the web UI is requested.

In step 800, the CPU 20A receives a request to display the web UI, and the process proceeds to step 802.

In step 802, the CPU 20A determines whether the current time is within a prescribed time from the most recent firmware update. If the determination is negative, the process proceeds to step 804; if affirmative, the process proceeds to step 806.

In step 804, the CPU 20A performs normal display on the web UI, and ends the processing sequence. That is, the web UI is displayed without being highlighted.

On the other hand, in step 806, the CPU 20A determines whether a new function has been added by the most recent firmware update. If the determination is negative, the process proceeds to step 804 described above; if affirmative, the process proceeds to step 808.

In step 808, the CPU 20A highlights the setting change menu for the new function on the web UI, and ends the processing sequence. For example, the alert icon 64 is highlighted, with an indication “New function has been added. Setting can be changed from here”, as illustrated in the upper portion of FIG. 17. Then, when an operation is performed on the alert icon 64, the new function items are displayed, as illustrated in the lower portion of FIG. 17.

As described above, in the present exemplary embodiment, the setting change menu is highlighted upon detection of an update of predetermined software that adds a new function. Thus, the setting change menu can be appropriately highlighted in accordance with the contents of an event even when the event is not started by the user. Therefore, the user can access and deal with the item to be changed earlier and more easily.

In the above exemplary embodiments, the processes are described as being performed in the image forming apparatus 12. However, this is not a limitation, and the processes may be performed in an image processing apparatus or an image reading apparatus. Further, part of the processes may be performed by the server 11, the client computer 14, the portable terminal device 16, or the like. For example, the process of providing the web UI may be performed by the server 11, the client computer 14, the portable terminal device 16, or the like.

In the above-described exemplary embodiments, the processor refers to a processor in a broad sense and includes a general-purpose processor (for example, a CPU) or a dedicated processor (for example, a Graphics Processing Unit or GPU; an Application Specific Integrated Circuit or ASIC; a Field Programmable Gate Array or FPGA; or a programmable logic device).

Further, the operation of the processor described in the exemplary embodiments may be performed not only by a single processor but also by a plurality of processors present at physically distant positions cooperating with each other. In addition, the order of the respective operations of the processor is not limited only to the order described in the respective exemplary embodiments described above, but may be appropriately changed.

While the “system” according to the exemplary embodiments has been described as being constituted by a plurality of devices by way of example, the system may be constituted by a single apparatus having some of the functions of the plurality of devices.

The processes performed by the image forming apparatus 12 according to the above-described exemplary embodiments may include a process performed by software, a process performed by hardware, or a process combining both of them. The processes performed by the image forming apparatus 12 may be stored as a program in a storage medium and distributed.

The present disclosure is not limited to the foregoing, and various modifications and implementations are of course possible without departing from the spirit thereof.

With respect to the above exemplary embodiments, the following appendix is further disclosed.

### APPENDIX

(((1)))

An information processing system comprising:
a processor configured to:
   detect a state necessitating a setting change, and
   perform a process of highlighting a setting change menu on a web user interface in a case in which the web user interface is accessed after the detection of the state.
      (((2)))

The information processing system according to (((1))), wherein the processor is configured to perform the process of highlighting in a case in which the web user interface is accessed within a predetermined time after the detection of the state.

(((3)))

The information processing system according to (((1))) or (((2))), wherein the processor is configured to detect, as the state, a launch of a guidance application for providing guidance toward the web user interface.

(((4)))

The information processing system according to (((3))), wherein the processor is configured to detect, as the launch of the guidance application, an instruction to display a guidance screen for providing guidance toward the web user interface or a display of the guidance screen.

((((5)))

The information processing system according to any one of (((1))) to ((((4))), wherein the processor is configured to detect, as the state, an occurrence of a launch error due to a function requiring advance setting being launched in an unset state.

(((6)))

The information processing system according to (((5))), wherein the processor is configured to detect, as the launch error, a display of an error screen prompting a setting change due to the occurrence of the launch error.

(((7)))

The information processing system according to (((5))) or (((6))), wherein the processor is configured to highlight a setting item for eliminating the launch error in a case in which the setting change menu is operated.

((((8)))

The information processing system according to any one of (((1))) to ((((7))), wherein the processor is configured to detect, as the state, an occurrence of an error necessitating a setting change.

(((9)))

The information processing system according to (((8))), wherein the processor is configured to highlight a setting item for eliminating the error in a case in which the setting change menu is operated.

(((10)))

The information processing system according to any one of (((1))) to (((9))) except for (((2))), wherein the processor is configured to detect, as the state, an update of predetermined software that adds a new function.

(((11)))

The information processing system according to (((10))), wherein the processor is configured to display the new function due to the update of the software in a case in which the setting change menu is operated.

(((12)))

An information processing program for causing a computer to execute a process, the process comprising:
detecting a state necessitating a setting change; and
performing a process of highlighting a setting change menu on a web user interface in a case in which the web user interface is accessed after the detection of the state.

What is claimed is:

1. An information processing system comprising:
a processor configured to:
detect a state necessitating a setting change, and
perform a process of highlighting a setting change menu on a web user interface in a case in which the web user interface is accessed after the detection of the state.

2. The information processing system according to claim 1, wherein the processor is configured to perform the process of highlighting in a case in which the web user interface is accessed within a predetermined time after the detection of the state.

3. The information processing system according to claim 1, wherein the processor is configured to detect, as the state, a launch of a guidance application for providing guidance toward the web user interface.

4. The information processing system according to claim 3, wherein the processor is configured to detect, as the launch of the guidance application, an instruction to display a guidance screen for providing guidance toward the web user interface or a display of the guidance screen.

5. The information processing system according to claim 1, wherein the processor is configured to detect, as the state, an occurrence of a launch error due to a function requiring advance setting being launched in an unset state.

6. The information processing system according to claim 5, wherein the processor is configured to detect, as the launch error, a display of an error screen prompting a setting change due to the occurrence of the launch error.

7. The information processing system according to claim 5, wherein the processor is configured to highlight a setting item for eliminating the launch error in a case in which the setting change menu is operated.

8. The information processing system according to claim 1, wherein the processor is configured to detect, as the state, an occurrence of an error necessitating a setting change.

9. The information processing system according to claim 8, wherein the processor is configured to highlight a setting item for eliminating the error in a case in which the setting change menu is operated.

10. The information processing system according to claim 1, wherein the processor is configured to detect, as the state, an update of predetermined software that adds a new function.

11. The information processing system according to claim 10, wherein the processor is configured to display the new function due to the update of the software in a case in which the setting change menu is operated.

12. A non-transitory computer readable medium storing a program causing a computer to execute a process for information processing, the process comprising:
detecting a state necessitating a setting change; and
performing a process of highlighting a setting change menu on a web user interface in a case in which the web user interface is accessed after the detection of the state.
